(19) United States
(12) Patent Application Publication
(10) Pub. No.: US 2005/0018855 A1
(43) Pub. Date: Jan. 27, 2005

(54) Method for producing hygiene articles

(76) Inventor: Walter Kramer, Bonn (DE)

Correspondence Address: LERNER AND GREENBERG, PA, P O BOX 2480, HOLLYWOOD, FL, 33022-2480, US

(21) Appl. No.: 10/492,114

(22) PCT Filed: Oct. 7, 2002
(86) PCT No.: PCT/DE02/03762

(30) Foreign Application Priority Data
Oct. 12, 2001 (DE) 10150519.1
Oct. 9, 2001 (DE) 10149772.5

(51) Int. Cl. B31C 1/00; B65H 81/00

(52) U.S. Cl. 381/1; 156/184

(57) ABSTRACT

The present invention relates to a process for producing an improved film/nonwoven laminate from a fibrous nonwoven web and a polymeric film wherein the nonwoven web and polymeric film are bonded together by passing the nonwoven web and the polymeric film through the nip between two rolls. One of the rolls is in contact with polymeric film. This roll has a surface that is made from a soft material that deforms under nip pressure.

The invention relates to a method for producing hygiene articles which structurally comprise five webs and which are finished in production terms preferably as complete baby diapers.

DE 40 41 228 has hitherto disclosed a solution for producing a hygienic sheet with increased absorbency, in which a cellulose board web is processed by mechanical treatment into a bulky fluff layer, a wash protection sheet web is delivered parallel to the fluff layer, and these webs are jointly wrapped in cellulose tissue and nonwoven. This solution is characterized in that an aqueous suspension of a superabsorber is applied to the basic layer, that is to say the cellulose board.

This solution has the disadvantage, however, that the hygienic sheet obtained in this way must still undergo considerable additionally following processing, in order, for example, to produce a complete, that is to say finished baby diaper. This refers particularly to the adhesive bonding or heat-sealing of edges or else to equipping with a hook-and-loop fastening which has to be manufactured separately and applied later.

Moreover, a further solution is known, in which a three-web basic sheet breathable on the outside and a sealing sheet arranged in the middle and heat-sealed or adhesively bonded at the sides are connected to one another.

This solution, too, has the disadvantage that the fastenings, as adhesive or else hook-and-loop fastenings, have to be manufactured separately and applied afterward. This subsequent outlay needlessly increases the cost of the article and is economically counterproductive.

DE 201 00 065 discloses a further solution for a diaper with releasable fastenings which is characterized in that the diaper is provided with position markings on its fastening parts.

This solution has the disadvantage that, apart from its fastening parts with markings, it has no actual structure which, by virtue of its arrangement, is capable of giving rise to a high liquid absorbency.

Finally, the solution of a three-web basic sheet is also known, which is designed to be breathable on the outside and in the middle has a sealing sheet which is heat-sealed or adhesively bonded on the mutually abutting sides, the fastenings, as adhesive or hook-and-loop fastenings, being manufactured and applied separately.

This solution has the disadvantage that a highly complicated production method is necessary in order to produce this article. At least three to four operations are required, independently of an extruded production of the sheet. This production is highly cost-intensive and likewise has the effect of increasing the price of the final article. Moreover, disposal presents problems.

The set object of the invention is, therefore, to provide a cost-effective method for producing hygiene articles in a single cycle, in which, in technological terms, the final product is made up after the extrusion process directly or inline. According to the invention, the production method is to have high production reliability, along with a favorable price/performance ratio. Furthermore, the basic material used is to be capable of being disposed of easily and without difficulty, and, moreover, the final product is to have consumer-friendly handling.

The object of the invention is achieved by means of the technical features indicated in the characterizing part of claim 1.

The essence of the invention lies in a composite structure of five webs which lie next to one another and which are produced in an extrusion process by means of two extruders and are subsequently made up directly or inline. The preferably polyethylene sheet, but also polypropylene sheet is produced in five webs by means of the two extruders via filtration and a metering pump and also a specific sheet die, equipped with a plurality of nozzles, via a casting/rolling assembly. In this case, the first extruder produces the middle and the two outer webs. The second extruder produces the two breathable webs which are arranged between the two outer webs so as to be placed on the middle web. The hook-and-loop fastening of the article is subsequently produced simultaneously in the production flow both on the casting roller and by means of a following pair of embossing rollers.

In order to bring about breathability, the sheet is drafted inline in the longitudinal direction. In a separate method, the breathable sheet, composed of a biological and a chemical polymer, is produced by process engineering by means of microwaves. In this case, the biological polymers are displaced out of the extruded sheet by means of microwaves. Finally, an absorbent pad is also applied to the liquid-tight middle web by the second extruder and is closed off by means of a liquid-permeable upper sheet, located above it, as a covering sheet which is equipped along the edge with a stretchable tape.

According to the invention, a compound of the polymer is obtained in the way described above by extrusion, the extrusion die used consisting of a multiduct sheet die nozzle, with the aid of which the five-web structure of the hygienic sheet is obtained. Finally, the formation of a hook-and-loop fastening is also carried out simultaneously inline during the production process by the second extruder and curling fiber is sprayed onto the outer web as a closing element for the hook-and-loop fastening.

The invention will be explained in more detail below by means of an exemplary embodiment. In the accompanying drawing:

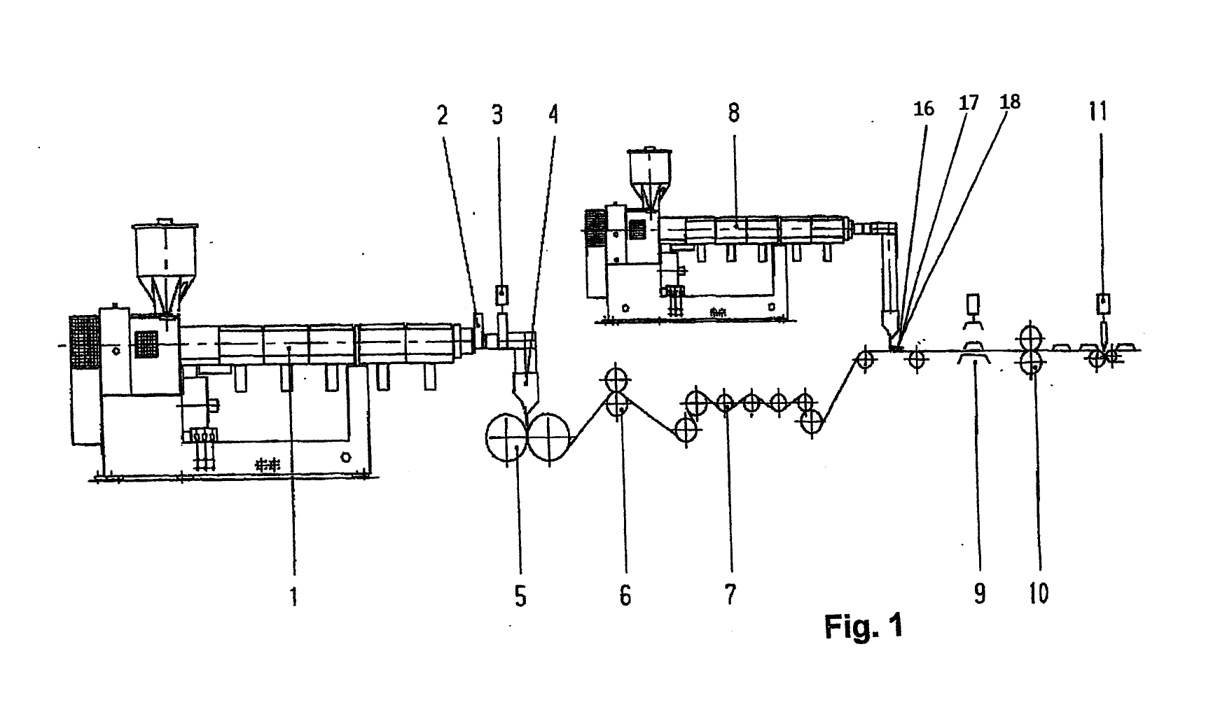

FIG. 1: shows diagrammatically the production plant with the flow sequence,

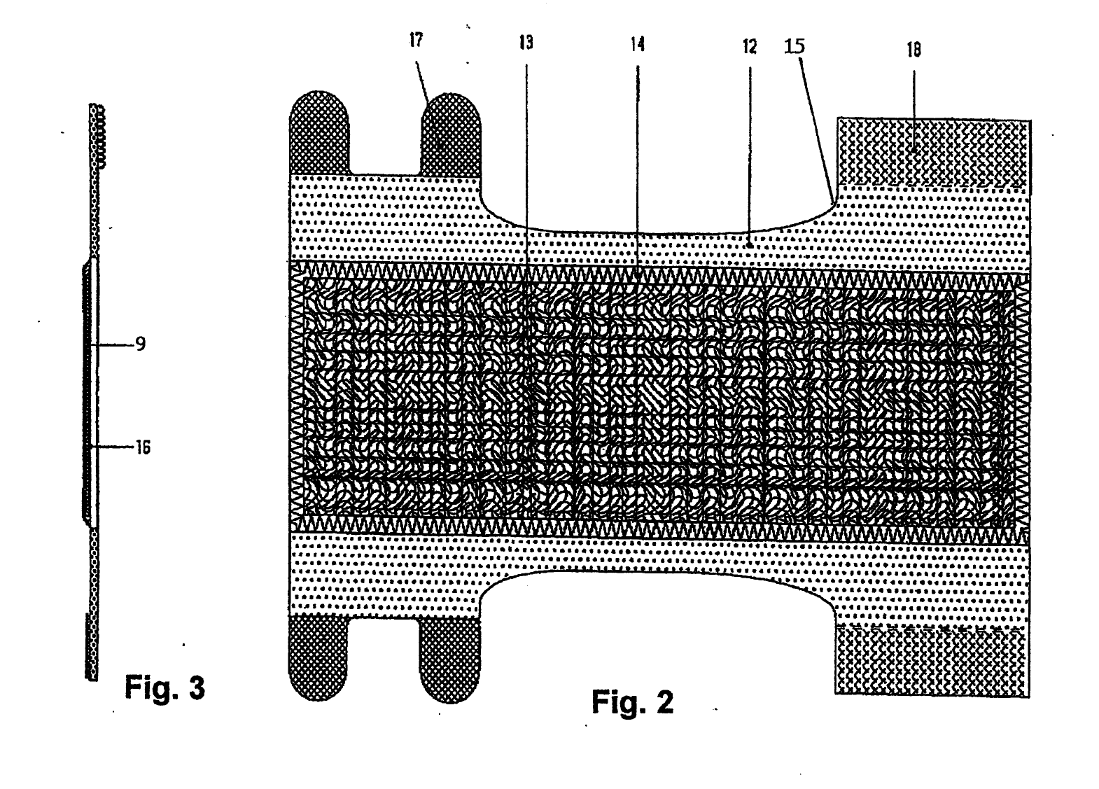

FIG. 2: shows a top view of the hygienic sheet,

FIG. 3: shows a section through the hygienic sheet.

A middle web 13 and two outer webs 12 are extruded by means of an extruder 1. In technological terms, all five ducts of a multiduct sheet die 4 are used for this process. As a result, in terms of process engineering, all five sheet webs which form the hygienic sheet are also extruded in one nip, which, in previous traditional manufacture, involved a plurality of operations which are now combined in a complex manner. In the extrusion process, filtration 2 through a screen is arranged, and, following this, a metering pump 3 is incorporated, polyethylene, as the preferred material used, being led over the abovementioned sheet die 4 and a pair of casting rollers 5. Subsequently, the webs thus extruded run as the middle web 13 and the two outer webs 12 through a pair of forming rollers 6, from where they are transferred into a following drafting zone 7. Here, the drafting of the sheet webs in the longitudinal direction takes place inline, with the result that good breathability is brought about. After the inline drafting 7, an absorbent pad 16 is applied by the second extruder 8. Finally, in the further production process, a liquid-permeable covering sheet 9 is applied to the hygienic sheet and is also equipped at its edge with a stretchable tape 14. There follows the station with form cutting 10, according to the exemplary embodiment the curved lateral incisions 19 being cut out for baby diapers. Immediately thereafter, the finished hygiene article is cut to the desired length of the product in the cutting-to-length station 11.

As indicated, according to the exemplary embodiment, a hygiene article in the form of a baby diaper is produced, complete, in a single work cycle, said baby diaper consisting of the two breathable outer webs 12 as a breathable film web and of a liquid-tight middle web 13 equipped with a covering sheet 9 which is provided along the edge with a stretchable tape 14. Finally, an absorbent pad (16) with a liquid-permeable covering sheet 9 is formed, and a hook-and-loop fastening 17 with preferably two hook-and-loop tongues is arranged on the outer region of the outer webs 12. The two hook-and-loop tongues of the hook-and-loop fastening 17 are securely connected, during subsequent use, to the curling fiber 18 arranged in the same position, thus ensuring a reliable closing of the baby diaper. The rounded incision 15, which is brought about in the form-cutting station 10, serves merely for a good body fit of the baby diaper and shows that an operation of this kind is incorporated into the production cycle without difficulty.

List of Reference Symbols Used

1 Extruder
2 Filtration
3 Metering pump
4 Multiduct sheet die
5 Pair of casting rollers
6 Pair of forming rollers
7 Inline drafting
8 Extruder
9 Liquid-permeable covering sheet
10 Form cutting
11 Cutting to length
12 Outer web breathable film web (polypropylene)
13 Middle web (liquid-tight web PE, PP)
14 Stretchable tape
15 Incision
16 Absorbent pad
17 Hook-and-loop fastening (hook-and-loop tongue; two webs)
18 Curling fiber

1-6. (canceled).

7. A method for producing hygiene articles, which comprises:
providing two extruders and a multiduct sheet die;
extruding the hygiene articles in the two extruders during a single production cycle with five-ply sheet webs in a compound structure;
during the extruding, inline drafting the sheet in a longitudinal direction for increasing a breathability thereof, and applying hook-and-loop fastening devices onto breathable film webs forming laterally outer webs of the hygiene articles.

8. The method according to claim 7, wherein the hook-and-loop fastening includes regions with loop fibers and regions with crimped fibers.

9. The method according to claim 7, which comprises extruding the hook-and-loop fastening on two tongues on each lateral side of the hygiene articles.

10. The method according to claim 7, which comprises extruding the hygiene articles in the form of baby diapers.

11. The method according to claim 7, which comprises extruding, via a screen as filtration and via a metering pump of one of the two extruders, a middle web forming a liquid-tight web and two outer webs forming breathable film webs.

12. The method according to claim 7, wherein the step of forming the hook-and-loop fastening together with the associated curling fiber is effected by one of the two extruders on two outer webs of the hygiene article.

13. The method according to claim 12, wherein each of the outer webs has two tongues and the hook-and-close fastening is extruded onto the two tongues.

14. The method according to claim 7, which comprises applying an absorbent pad to the liquid-tight middle web with one of the extruders, and closing off the absorbent pad upwardly by applying a liquid-permeable covering sheet and placing stretchable tape along an edge thereof.

15. The method according to claim 7, which comprises forming the hygiene article in a form-cutting station with an incision, the incision serving for expedient body fitting of the hygiene article, and, finally, cutting the hygiene article to a made-up length in a cutting-to-length station.

16. The method according to claim 7, which comprises extruding all five sheet webs in one process with the multiduct sheet die, guiding the webs via a pair of casting rollers, and subsequently delivering the webs to a pair of forming rollers for forming the sheets, and subsequently performing the inline drafting, with a subsequent application of a liquid-permeable covering sheet and edge-placed stretchable tapes.
